(19) United States
(12) Patent Application Publication
(10) Pub. No.: US 2021/0331075 A1
(43) Pub. Date: Oct. 28, 2021

(54) NON-TRANSITORY COMPUTER-READABLE MEDIUM AND VIDEO GAME PROCESSING SYSTEM

(71) Applicant: SQUARE ENIX CO., LTD., Tokyo (JP)

(72) Inventors: Takamasa SHIBA, Tokyo (JP); Hiroshi KOBAYASHI, Tokyo (JP); Jun WAGA, Tokyo (JP); Yutaka YOSHIDA, Tokyo (JP)

(73) Assignee: SQUARE ENIX CO., LTD., Tokyo (JP)

(21) Appl. No.: 17/231,960

(22) Filed: Apr. 15, 2021

(30) Foreign Application Priority Data
Apr. 22, 2020 (JP) 2020-076299

(51) Int. Cl. A63F 13/73; A63F 13/45; A63F 13/79; A63F 13/216

(52) U.S. Cl. CPC A63F 13/73; A63F 13/45; A63F 2300/5546; A63F 13/216; A63F 13/79

(57) ABSTRACT

A non-transitory computer-readable medium including a video game processing program for causing a server to perform functions to control progress of a video game is provided. Display of information regarding a second user is restricted using positional information of a user terminal of a first user and information regarding a virtual space corresponding to map information of a real space. The functions includes: a displaying function configured to arrange an object corresponding to the second user who satisfies a predetermined condition as a corresponding object, and display the corresponding object at a position in the virtual space corresponding to a position of the second user in the real space; and a giving function configured to give a privilege specified based on a user operation against the corresponding object to at least any of the first user and the second user corresponding to the corresponding object.

### CROSS-REFERENCE TO RELATED APPLICATION

The present application claims priority to and the benefit of in Japanese Patent Application No 2020-076299 filed on Apr. 22, 2020, the disclosure of which is expressly incorporated herein by reference in its entirety for any purpose.

### BACKGROUND

At least one of embodiments of the present disclosure relates to a non-transitory computer-readable medium including a video game processing program and a video game processing system for causing a server to perform functions to control progress of a video game in which display of information regarding a second user is restricted using positional information of the user terminal of a first user and information regarding a virtual space corresponding to map information of a real space.

In recent years, various systems each using positional information of a user terminal have been proposed in a field of video games.

In such a system, there is one in which a user terminal is caused to display map information of a real space containing positional information of the user terminal, and a predetermined game event is generated in a case where the user terminal exists in a predetermined place in the real space. Examples of such system may be found in Japanese Patent Application Publication No. 2002-159742.

### SUMMARY

Now, in a system using positional information of a user terminal, there is one in which a user terminal is caused to display a virtual space corresponding to map information of a real space. Here, when objects corresponding to a plurality of users are displayed at positions corresponding to positional information respective user terminals of the users in a virtual space, there is a possibility that personal information of the user may not be protected due to the display using the positional information of the user terminal.

On the other hand, in a case where an object corresponding to each of the other users is not displayed in the virtual space, for example, interaction among the users in the virtual space during progress of a video game is reduced as compared with a case where the objects corresponding to the other users are displayed, whereby there has been a possibility that a sense of unity among the users, which the video game is being caused to proceed in the same virtual space, will be diminished, and this eventually causes interest of the users in the video game to be diminished.

It is an object of at least one of embodiments of the present disclosure to solve the problem described above, and to maintain interest of a user in a video game.

According to one non-limiting aspect of the present disclosure, there is provided a non-transitory computer-readable medium including a video game processing program for causing a server to perform functions to control progress of a video game. In the video game, display of information regarding a second user is restricted using positional information of a user terminal of a first user and information regarding a virtual space corresponding to map information of a real space.

The functions include a displaying function configured to arrange an object corresponding to the second user who satisfies a predetermined condition for the first user as a corresponding object, and display the corresponding object at a position in the virtual space corresponding to a position of the second user in the real space for the first user.

The functions also include a giving function configured to give a privilege to at least any of the first user and the second user corresponding to the corresponding object, the privilege being specified on a basis of a user operation against the corresponding object.

According to another non-limiting aspect of the present disclosure, there is provided a video game processing system for controlling progress of a video game. In the video game, display of information regarding a second user is restricted using positional information of a user terminal of a first user and information regarding a virtual space corresponding to map information of a real space. The video game processing system includes a communication network, a server, and a user terminal.

The video game processing system includes a display controller configured to arrange an object corresponding to the second user who satisfies a predetermined condition for the first user as a corresponding object, and display the corresponding object at a position in the virtual space corresponding to a position of the second user in the real space for the first user.

The video game processing system also includes a giver configured to give a privilege to at least any of the first user and the second user corresponding to the corresponding object, the privilege being specified on a basis of a user operation against the corresponding object.

According to still another non-limiting aspect of the present disclosure, there is provided a non-transitory computer-readable medium including a video game processing program for causing a user terminal to perform functions to control progress of a video game in the video game, display of information regarding a second user is restricted using positional information of a user terminal of a first user and information regarding a virtual space corresponding to map information of a real space.

The functions include a displaying function configured to arrange an object corresponding to the second user who satisfies a predetermined condition for the first user as a corresponding object, and display the corresponding object at a position in the virtual space corresponding to a position of the second user in the real space for the first user.

The functions also include a giving function configured to give a privilege to at least any of the first user and the second user corresponding to the corresponding object, the privilege being specified on a basis of a user operation against the corresponding object.

According to each of the embodiments of the present application, one or two or more shortages are solved.

### BRIEF DESCRIPTION OF DRAWINGS

The foregoing and other objects, features and advantages of the present disclosure will become more readily apparent from the following detailed description of preferred embodiments of the present disclosure that proceeds with reference to the appending drawings:

FIG. 1 is a block diagram illustrating an example of a configuration of a video game processing system corresponding to at least one of the embodiments of the present disclosure;

FIG. 2 is a block diagram illustrating a configuration of a server corresponding to at least one of the embodiments of the present disclosure;

FIG. 3 is a flowchart illustrating an example of game processing corresponding to at least one of the embodiments of the present disclosure;

FIG. 4 is a flowchart illustrating an example of an operation of a server in the game processing corresponding to at least one of the embodiments of the present disclosure;

FIG. 5 is a flowchart illustrating an example of an operation of a terminal in the game processing corresponding to at least one of the embodiments of the present disclosure;

FIG. 6 is a block diagram illustrating a configuration of a server corresponding to at least one of the embodiments of the present disclosure;

FIG. 7 is a flowchart illustrating an example of game processing corresponding to at least one of the embodiments of the present disclosure;

FIG. 8 is a block diagram illustrating a configuration of a server corresponding to at least one of the embodiments of the present disclosure;

FIG. 9 is a flowchart illustrating an example of game processing corresponding to at least one of the embodiments of the present disclosure;

FIG. 10 is a block diagram illustrating a configuration of a server corresponding to at least one of the embodiments of the present disclosure;

FIG. 11 is a flowchart illustrating an example of game processing corresponding to at least one of the embodiments of the present disclosure;

FIG. 12 is a block diagram illustrating a configuration of a server corresponding to at least one of the embodiments of the present disclosure;

FIG. 13 is a flowchart illustrating an example of game processing corresponding to at least one of the embodiments of the present disclosure;

FIG. 14 is a block diagram illustrating a configuration of a server corresponding to at least one of the embodiments of the present disclosure;

FIG. 15 is an explanatory drawing for explaining an example of a storage state of information corresponding to at least one of the embodiments of the present disclosure;

FIG. 16 is a flowchart illustrating an example of game processing corresponding to at least one of the embodiments of the present disclosure;

FIG. 17 is an explanatory drawing illustrating an example of a display screen corresponding to at least one of the embodiments of the present disclosure; and

FIGS. 18A and 18B are explanatory drawings illustrating examples of the display screen corresponding to at least one of the embodiments of the present disclosure.

### DETAILED DESCRIPTION

Hereinafter, examples of embodiments according to the present disclosure will be described with reference to the drawings Note that various components in the respective embodiments described below can be appropriately combined without any contradiction or the like. In addition, the description of the content described as a certain embodiment may be omitted in another embodiment. Further, the content of an operation or processing that does not relate to features of each of the embodiments may be omitted. Moreover, the order of various processes that constitute various flows described below may be changed without any contradiction or the like of processing content.

### First Embodiment

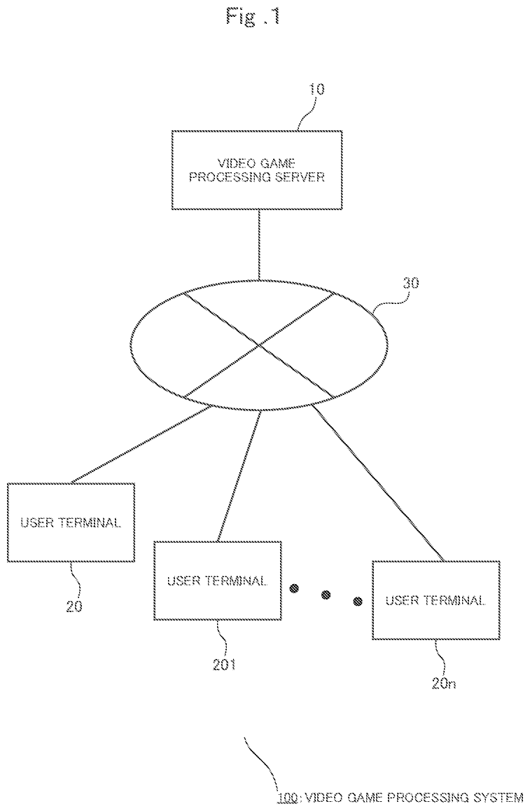

FIG. 1 is a block diagram illustrating an example of a configuration of a video game processing system 100 according to one embodiment of the present disclosure. As illustrated in FIG. 1, the video game processing system 100 includes a video game processing server 10 (hereinafter, referred to as a “server 10”) and user terminals 20, and 201 to 20N (“N” is an arbitrary integer) respectively used by users of the video game processing system 100. In this regard, the configuration of the video game processing system 100 is not limited to this configuration. The video game processing system 100 may be configured so that the plurality of users uses a single user terminal, or may be configured so as to include a plurality of servers.

Each of the server 10 and the plurality of user terminals 20 and 201 to 20N is connected to a communication network 30 such as the Internet, in this regard, although it is not illustrated in the drawings, the plurality of user terminals 20 and 201 to 20N is connected to the communication network 30 by executing data communication with base stations managed by a telecommunication carrier by means of a radio communication line.

The video game processing system 100 includes the server 10 and the plurality of user terminals 20 and 201 to 20N, whereby various kinds of functions for executing various kinds of processing in response to an operation of the user are performed.

The server 10 is managed by an administrator of the video game processing system 100, and has various kinds of functions to provide information regarding various kinds of processing to the plurality of user terminals 20 and 201 to 20N. In the present embodiment, the server 10 is constructed by an information processing apparatus, such as a WWW server, and includes a storage medium for storing various kinds of information. In this regard, the server 10 is provided with a general configuration for executing the various kinds of processing as a computer, such as a control section and a communicating section. However, its explanation herein is omitted. Further, in the video game processing system 100, it is preferable that the server 10 manages various kinds of information from a point of view to reduce a processing load on each of the plurality of user terminals 20 and 201 to 20N. However, a storing section for storing various kinds of information may include a storage region in a state that the server 10C an access the storage region. For example, the server 10 may be configured so as to be provided with a dedicated storage region outside the server 10.

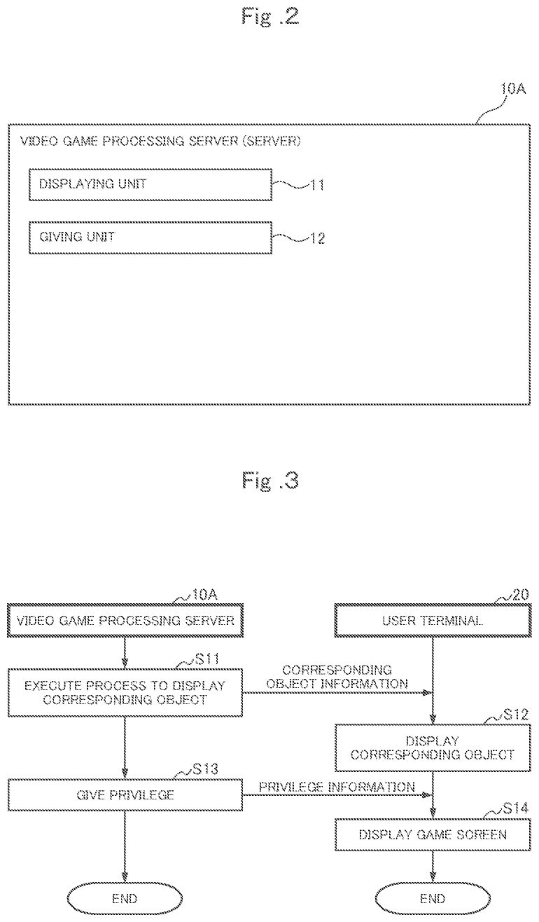

FIG. 2 is a block diagram illustrating a configuration of a video game processing server 10A (hereinafter, referred to as a “server 10A”), which is an example of the server 10. As illustrated in FIG. 2, the server 10A at least includes a displaying unit 11 (corresponding to a “display controller”) and a giving unit 12 (corresponding to a “giver”).

The displaying unit 11 has a function to arrange an object corresponding to another user (that is, the other user or a second user), who satisfies a predetermined condition for a user (that is, a first user), (hereinafter, referred to as a “corresponding object”) and display the corresponding object at a position in a virtual space corresponding to a position of the other user in a real space for the user.

Here, the predetermined condition means a condition of the other user for which the corresponding object can be displayed for the user. The predetermined condition is not limited particularly. However, it is preferable that the predetermined condition is a condition that allows the user to recognize that the condition is satisfied in the video game. As examples of the predetermined condition, there are a condition that the other user is associated with the user, and a condition that the other user has a common point with the user in the video game.

Further, the other user means a user different from one user who uses the user terminal 20. Namely, the other user means a user different from each user himself or herself. In this regard, it is preferable that the other user uses a user terminal (for example, user terminal 201) different from the user terminal 20 of the user.

Further, the position in the virtual space corresponding to the position of the other user in the reel space means a rule for defining a position in the virtual space using positional information of the user terminal 201 of the other user and map information of the real space. Here, the positional information of the user terminal 201 means information indicating a position of the user terminal 201 in the real space. A configuration of the positional information is not limited particularly. However, it is preferable that the positional information is configured so as to contain coordinates that can specify the position of the user terminal 201 in the real space. As examples of the configuration to obtain the positional information of the user terminal 201, there are a configuration to obtain the positional information by using a GPS signal, and a configuration to obtain the positional information on the basis of reception intensify information of wireless signals from a plurality of beacon transmitters.

Further, the virtual space corresponding to the map information of the real space means a virtual space that is generated by using the map information of the real space. A configuration to generate the virtual space is not limited particularly. However, it is preferable that the displaying unit 11 is configured so that the user can recognize that the virtual space is generated on the basis of the map information of the real space. As an example of such a configuration, there is a configuration in which the virtual space is generated by respectively arranging objects corresponding to roads and buildings in the real space at positions corresponding to roads and buildings in the real space. In this regard, a configuration to associate the position in the real space with the position in the virtual space is not limited particularly. However, the displaying unit 11 may be configured so that a coordinate in the real space and a coordinate in the virtual space are defined in a one-to-one relationship, or may be configured so that the coordinates are defined in a plural-to-one relationship or a one-to-plural relationship

Further, the phrase “arrange the corresponding object” means that the corresponding object is associated with a position in the virtual space Further, the phrase “display the corresponding object for the user” means that an image of the arranged corresponding object is included in a game screen displayed by the user terminal 20 of the user. A configuration to display the corresponding object for the user is not limited particularly. However, it is preferable that the displaying unit 11 is configured so that in a case where the position of the arranged corresponding object is included in a display region of the user terminal 20, the image of the corresponding object is included in the game screen displayed by the user terminal 20 of the user. Here, the display region of the user terminal 20 means a display range of the virtual space displayed by the user terminal 20, which is defined on the basis of the position of the user in the real space, in this regard, the verb “display” herein includes that the user terminal 20 mainly executes a process to display an image, and that the server 10A mainly executes a process to cause the user terminal 20 to display an image.

In this regard, a configuration to display the corresponding object for the user is not limited particularly. The displaying unit 11 may be configured so as to adjust the position of the corresponding object and display the corresponding object for the user. Here, the phrase “adjust the position of the corresponding object” means that another position of the corresponding object is determined. A configuration to adjust the position of the corresponding object is not limited particularly The displaying unit 11 may be configured so as to determine another position of the corresponding object in the virtual space on the basis of the position of the corresponding object and the position of the user in the real space. As an example of the configuration to adjust the position of the corresponding object, there is a configuration in which another position is determined so that a distance between the position in the virtual space corresponding to the position of the user in the real space and the position of the arranged corresponding object is set to be a predetermined distance or shorter. Further, the configuration to adjust the position of the corresponding object is not limited particularly. The displaying unit 11 may be configured so as to determine another position in the virtual space on the basis of the position of the arranged corresponding object and a user operation regarding the corresponding object. As an example of the user operation against the corresponding object, there is a touch operation against the corresponding object displayed by the user terminal 20.

Here, the phrase “adjust the position of the arranged corresponding object and display the corresponding object for the user” means that the corresponding object is displayed at a position defined in accordance with a predetermined adjustment rule from an arrangement position of the corresponding object The adjustment rule is not limited particularly. However, it is preferable that the adjustment rule is a rule that the position is defined on the basis of a position of the other user, who satisfies a predetermined condition for the user, in virtual space. As an example of the adjustment rule, there is a rule that a position in the virtual space corresponding to a position of the other user, who satisfies the predetermined condition for the user, in the real space or a position within a predetermined distance from the position is defined.

The giving unit 12 has a function to give a specified privilege to at least any of the user and the other user corresponding to the corresponding object on the basis of a user operation against the corresponding object.

Here, tire user operation against the corresponding object means an operation by the user against the corresponding object displayed by the displaying unit 11. The user operation against the corresponding object is not limited particularly. However, it is preferable that the user operation is an operation by which an object of an operation target by the user can be specified. As an example of the user operation against the corresponding object, there is a selection operation against the corresponding object displayed on a display screen of the user terminal 20 or information regarding the corresponding object. In this regard, the user operation against the corresponding object is not limited particularly. The user operation may be a set of user operations respectively carried out against corresponding objects corresponding to a plurality of other users.

Further, the privilege means what is given to the user on the basis of the user operation. The privilege may be an element that can be used by the user, or an element that cannot be used by the user. The content thereof is not limited particularly. As examples of the privilege, there are an in-game element, a right in the video game (for example, a right to transmit a message to the other user, or a participation right in a predetermined event), and occurrence of a temporary process in the video game (for example, occurrence of a so-called buff, sharing of an item effect, or an increase in item appearance ratio).

Each of the plurality of user terminals 20, and 201 to 20N is managed by the user, and is configured by a communication terminal capable of playing a network delivery type game, such as a cellular telephone terminal, a PDA (Personal Digital Assistants), a portable game apparatus, or a so-called wearable device, for example, in this regard, the configuration of the user terminal that the video game processing system 100 can include is not limited to the example described above. Each of the user terminals 20, and 201 to 20N may be configured so that the user can recognize the video game. As the other examples of the user terminal, there are one obtained by combining various kinds of communication terminals, a personal computer, and a stationary game apparatus.

Further, each of the plurality of user terminals 20, and 201 to 20N is connected to the communication network 30, and includes hardware (for example, a display device for displaying a browser screen or a game screen based on a coordinate and the like) and software for executing various kinds of processes by communicating with the server 10A. In this regard, each of the plurality of user terminals 20, and 201 to 20N may be configured so as to be able to directly communicate with each other without the server 10A.

Next, an operation of the video game processing system 100 (hereinafter, referred to as the “system 100”) according to the present embodiment will be described.

FIG. 3 is a flowchart illustrating an example of game processing executed by the system 100. In the game processing according to the present embodiment, processes related to a control of progress of the video game using the positional information of the user terminal 20 in response to an operation of the user are executed. Hereinafter, a case where the server 10A and the user terminal 20 (hereinafter, referred to as the “terminal 20”) execute the game processing will be described as an example.

The game processing is started as an opportunity that the terminal 20 accessing the server 10A requests display of the virtual space, for example.

In the game processing, the server 10A first executes a process to display an object corresponding to the other user who satisfies a predetermined condition for the user (that is, a corresponding object) at a position in a virtual space corresponding to a position of the other user in a real space, and arrange the corresponding object to the user (Step S11). In the present embodiment, the server 10A transmits corresponding object information for displaying the corresponding object to the terminal 20.

When the corresponding object information is received from the server 10A, the terminal 20 outputs a game screen including a corresponding object image to a display screen of a predetermined display device in a case where a display position of the corresponding object or a region corresponding to the corresponding object including the display position is included in a display region of the terminal 20 on the basis of the corresponding object information (Step S12).

The server 10A gives a specified privilege to at least any of the user and the other user corresponding to the corresponding object on the basis of a user operation against the corresponding object (Step S13). In the present embodiment, the server 10A transmits privilege information for giving the privilege to any user to the terminal 20.

When the privilege information is received from the server 10A, the terminal 20 outputs a game screen to the display screen of the predetermined display device on the basis of the privilege information (Step S14). In the present embodiment, when the terminal 20 outputs the game screen on the basis of the privilege information, the terminal 20 and the server 10A terminate the processes herein.

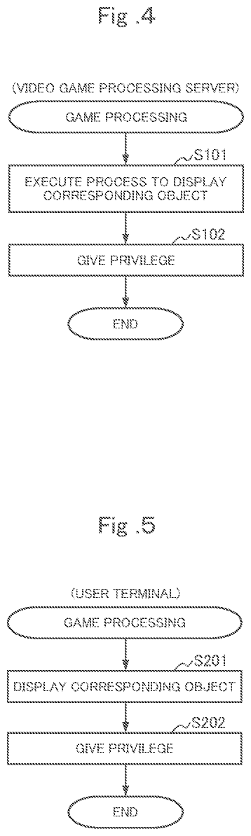

FIG. 4 is a flowchart illustrating an example of an operation of the server 10A in the game processing. Here, an operation of the server 10A in the system 100 will be described again.

In the game processing, the server 10A first executes a process to display an object corresponding to the other user who satisfies a predetermined condition for the user (that is, a corresponding object) at a position in a virtual space corresponding to a position of the other user in a real space, and arrange the corresponding object to the user (Step S101); and gives a specified privilege to at least any of the user and the other user corresponding to the corresponding object on the basis of a user operation against the corresponding object (Step S102). When the privilege is given to the user, the server 10A terminates the processes herein.

FIG. 5 is a flowchart illustrating an example of an operation of the terminal 20 in a case where the terminal 20 executes the game processing. Hereinafter, a case where the terminal 20 executes the game processing by a single body will be described as an example, in this regard, the configuration of the terminal 20 includes the similar functions to those of the server 10A except that the terminal 20 receives various kinds of information from the server 10A. For this reason, its explanation is omitted from a point of view to avoid repeated explanation.

In the game processing, the terminal 20 first displays an object corresponding to the other user who satisfies a predetermined condition for the user (that is, a corresponding object) at a position in a virtual space corresponding to a position of the other user in a real space, and arranges the corresponding object to the user (Step S201); and gives a specified privilege to at least any of the user and the other user corresponding to the corresponding object on the basis of a user operation against the corresponding object (Step S202). In the present embodiment, when the terminal 20 outputs the game screen on the basis of privilege information, the terminal 20 terminates the processes herein.

As explained above, as one aspect of the first embodiment, the server 10A provided with the functions to control progress of the video game using the positional information of the user terminal in response to the operation of the user is configured so as to include the displaying unit 11 and the giving unit 12. Thus, the displaying unit 11 displays an object corresponding to the other user who satisfies a predetermined condition for the user (that is, a corresponding object) at a position in a virtual space corresponding to a position of the other user in a real space, and arranges the corresponding object to the user; and the giving unit 12 gives a specified privilege to at least any of the user and the other user corresponding to the corresponding object on the basis of a user operation against the corresponding object. Therefore, it becomes possible to maintain interest of the user in the video game.

Namely, by not displaying information regarding the position of the other user in the real space in principle and providing the information regarding the position of the other specific user in the real space even in a state where the personal information of the user is protected, it is possible to prevent a sense of unity among the users, which the video game is being caused to proceed in the same virtual space, from being diminished so long as the personal information is properly protected, and as a result, it becomes possible to maintain interest of the user in the video game.

### Second Embodiment

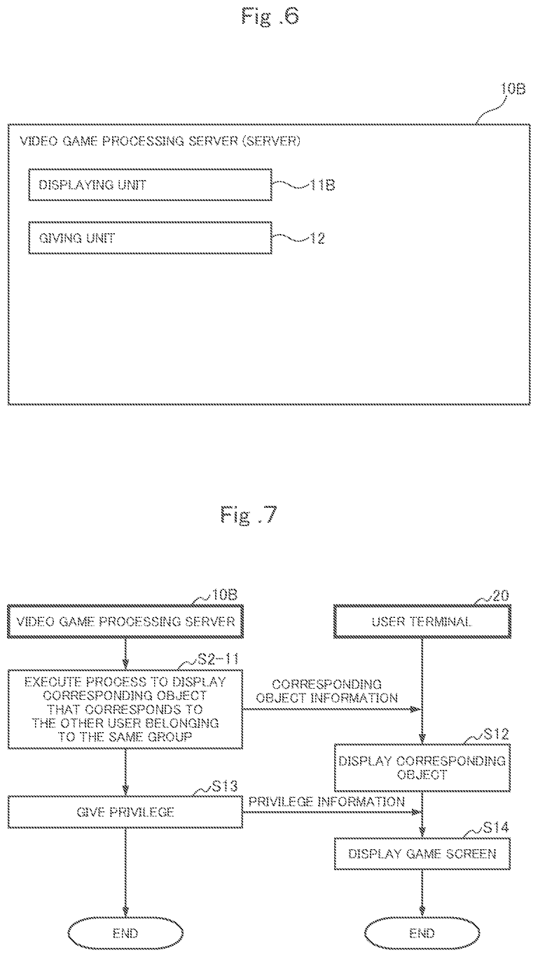

FIG. 6 is a block diagram illustrating a configuration of a video game processing the server 10B (hereinafter, referred to as a “server 108”), which is an example of the video game processing server 10. In the present embodiment, the server 108 at least includes a displaying unit 11B and a giving unit 12.

A predetermined condition according to the second embodiment is that the other user belongs to the same group as a user.

Here, the group means a set of a plurality of users (including the user and one or more other users) associated with each other. A configuration to associate the plurality of users with each other is not limited particularly. However, it is preferable that the server 108 is configured so that information regarding each of the plurality of users is stored in a storage unit to be associated with each other. As an example of the configuration to associate the plurality of users with each other, there is a configuration in which information regarding one or more characters corresponding to respective users is stored in a storage unit so as to be associated with each other.

The displaying unit 11B has a function to arrange an object corresponding to the other user who belongs to the same group as the user as a corresponding object, and display the corresponding object in a virtual space for the user.

FIG. 7 is a flowchart illustrating an example of game processing executed by the video game processing system 100 (see FIG. 1). Hereinafter, operations of the server 108 and a user terminal 20 (hereinafter, referred to as a “terminal 20”) will be described as an example. In this regard, a flowchart illustrating an operation of each of the server 10B and the terminal 20 is omitted from a point of view to avoid repeated explanation.

In the game processing, the server 10B arranges an object corresponding to the other user who belongs to the same group as the user as a corresponding object, and displays the corresponding object in a virtual space for the user (Step S2-11). In the present embodiment, the server 108 transmits corresponding object information for displaying the corresponding object to the terminal 20.

As explained above, as one aspect of the second embodiment, the server 10B provided with the functions to control progress of a video game using the positional information of the user terminal in response to the operation of the user is configured so as to include the displaying unit 11B and the giving unit 12. Thus, the displaying unit 11B arranges the object corresponding to the other user who belongs to the same group as the user as the corresponding object, and display the corresponding object in the virtual space for the user. Therefore, a sense of unity among the users that the video game is caused to proceed is further enhanced, and this makes it possible to maintain interest of the user in the video game.

### Third Embodiment

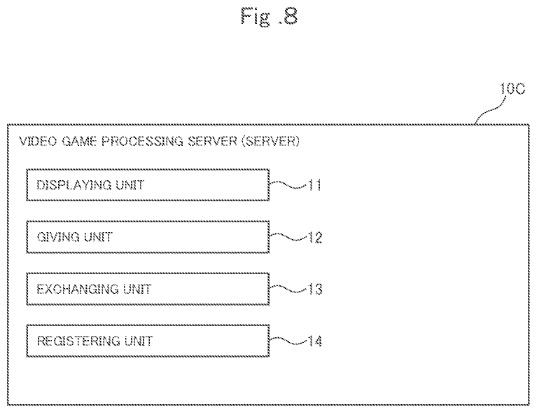

FIG. 8 is a block diagram illustrating a configuration of a video game processing server 10C (hereinafter, referred to as a “server 10C”), which is an example of the video game processing server 10. In the present embodiment, the server 10C at least includes a displaying unit 11, a giving unit 12, an exchanging unit 13, and a registering unit 14.

The exchanging unit 13 has a function to exchange user information between a user and another user (that is, the other user) in a case where an exchange request of the user information is received from the user or the other user.

Here, the user information means information regarding the user, and information that the user can identify. The user information is not limited particularly. However, it is preferable that the user information is fixed information set for each user. As examples of the user information, there are a user name and identification information assigned to each user. In this regard, as examples of the identification information assigned to each user, there are a code that is issued so that the user can identify the code, and a user ID assigned as unique information for each user.

Further, the exchange request of the user information means a request for exchanging user information among two or more users. The exchange request of the user information is not limited particularly. However, it is preferable that the exchange request of the user information is a request that restricts or specifies an exchange partner of user information. As an example of the exchange request of user information, there is an exchange request of identification information assigned to each user.

Further, the phrase “exchange user information” means that a process regarding exchange of user information among two users is executed on the basis of the exchange request of the user information. A configuration to exchange user information is not limited particularly. However, it is preferable that the exchanging unit 13 is configured so as to execute a process to exchange user information by an exchanging method specified on the basis of the exchange request of the user information. As examples of the configuration to exchange user information, there are a configuration in which transmission and reception of information is controlled so that each of two users obtains user information of the partner each other, and a configuration in which user information of a requesting user is transmitted to the other user and user information of the other user is transmitted to the requesting user in a case where the other user approves the exchange.

The registering unit 14 has a function to register the other user who exchanges the user information as the other user who satisfies a predetermined condition for the user on the basis of the user information exchanged by the exchanging unit 13.

Here, the phrase “register as the other user who satisfies a predetermined condition for the user” means that the user is associated with the other user on the basis of the user information of the other user. A configuration to register as the other user who satisfies a predetermined condition for the user is not limited particularly. However, it is preferable that the registering unit 14 is configured so that identification information of each of the user and the other user is associated with each other and is stored in a storage unit as a set of users. As an example of the configuration to register as the other user who satisfies a predetermined condition for the user, there is a configuration in which a user ID of a user and a user ID of the other user are registered so as to be associated with each other.

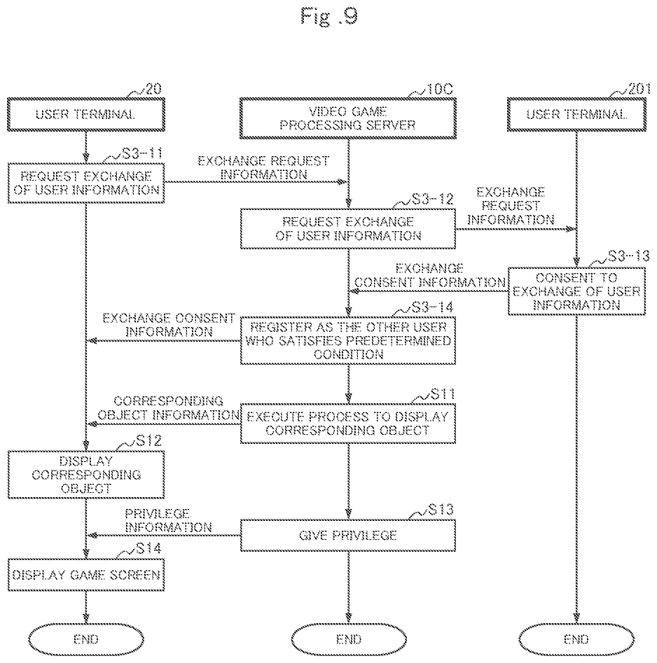

FIG. 9 is a flowchart illustrating an example of game processing executed by the video game processing system 100 (see FIG. 1). Hereinafter, operations of the server 10C. a user terminal 20 (hereinafter, referred to as a “terminal 20”), and a user terminal 201 (hereinafter, referred to as a “terminal 201”) will be described as an example. In this regard, a flowchart illustrating an operation of each of the server 10C and the terminal 20 is omitted from a point of view to avoid repeated explanation.

In the game processing, the terminal 20 first requests an exchange with user information of the other user (Step S3-11). In the present embodiment, the terminal 20 transmits exchange request information for exchanging user information to the server 10C.

When the exchange request information is received from the terminal 20, the server 10C requests the other user to exchange with the user information of the user (Step S3-12). In the present embodiment, the server 10C transmits the exchange request information for exchanging the user information, which contains the user information of the user, to the terminal 201.

When the exchange request information is received from the server 10C, the terminal 201 approves exchange of user information (Step S3-13). In the present embodiment, the terminal 201 transmits exchange approval information for exchanging the user information, which contains user information of the other user, to the server 10C.

When the exchange approval information is received from the terminal 201, the server 10C registers the other user who exchanged the user information on the basis of the exchange approval information as the other user who satisfies a predetermined condition for the user (Step S3-14). In the present embodiment, the server 10C transmits the exchange approval information for exchanging the user information, which contains the user information of the other user to the terminal 201.

As explained above, as one aspect of the third embodiment, the server 10C provided with the functions to control progress of a video game using the positional information of the user terminal in response to the operation of the user is configured so as to include the displaying unit 11, the giving unit 12, the exchanging unit 13, and the registering unit 14. Thus, in a case where the exchange request of the user information is received from the user or the other user, the exchanging unit 13 causes the user terminals 20, 201 to exchange the user information between the user and the other user; and the registering unit 14 registers the other user who exchanges the user information on the basis of the exchanged user information as the other user who satisfies the predetermined condition for the user. Therefore, it is possible to further activate interaction among the users, and this makes it possible to maintain interest of the user in the video game.

### Fourth Embodiment

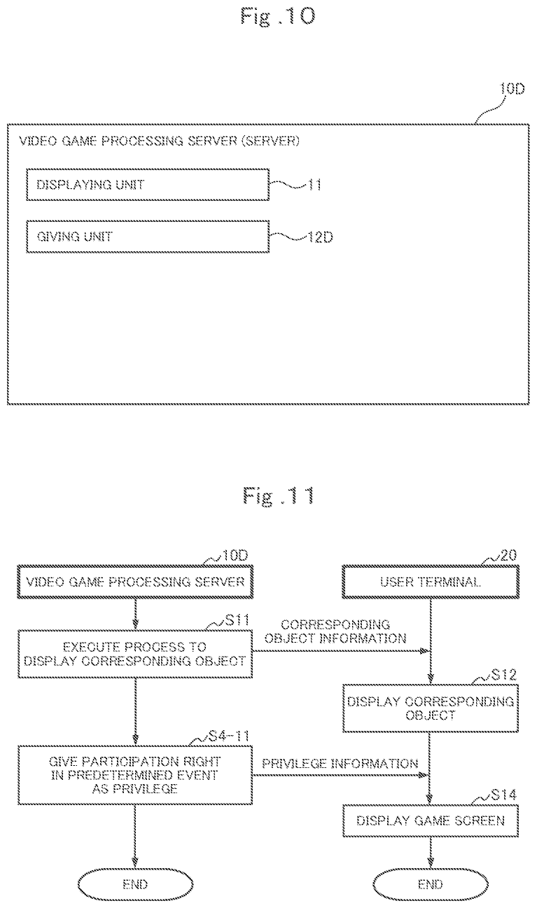

FIG. 10 is a block diagram illustrating a configuration of a video game processing server 10D (hereinafter, referred to as a “server 100”), which is an example of the video game processing server 10. In the present embodiment, the server 10D at least includes a displaying unit 11 and a giving unit 12D.

The giving unit 12D has a function to give a participation right in a predetermined event specified on the basis of a user operation to a user as a privilege in a case where the other user corresponding to a corresponding object against which the user operation is received is causing the predetermined event in a virtual space to proceed.

Here, the phrase “is causing the predetermined event to proceed (during progress of the predetermined event)” means that a generated predetermined event is being caused to proceed. The terminals phrase “is causing the predetermined event to proceed” is not limited particularly. However, it is preferable that such a situation may include preparation of a predetermined event. In timing of during progress of the predetermined event, during a battle and in preparation before start of a battle in a battle event are included.

Further, the participation right in the predetermined event means a right that one or more other users can participate in a predetermined event in progress. The participation right in the predetermined event is not limited particularly. However, it is preferable that the participation right in the predetermined event is a right is given in a state where the user can confirm the content of the predetermined event. As an example of the participation right in the predetermined event, there is a right to cause the user to participate in a predetermined event in a case where the user is notified of the content of the predetermined event and a request operation to participate in the predetermined event is received from the user.

FIG. 11 is a flowchart illustrating an example of game processing executed by the video game processing system 100 Hereinafter, operations of the server 10D and the user terminal 20 (hereinafter, referred to as the “terminal 20”) will be described as an example. In this regard, a flowchart illustrating an operation of each of the server 10D and the terminal 20 is omitted from a point of view to avoid repeated explanation.

The server 10D gives a user a participation right in a predetermined event specified on the basis of a user operation as a privilege (Step S4-11). In the present embodiment, the server 10D transmits privilege information for giving the user the privilege to the terminal 20.

As explained above, as one aspect of the fourth embodiment, the server 10D provided with the functions to control progress of a video game using the positional information of the user terminal in response to the operation of the user is configured so as to include the displaying unit 11 and the giving unit 12D. Thus, the giving unit 12D gives the participation right in the predetermined event specified on the basis of the user operation to the user as the privilege in a case where the other user corresponding to the corresponding object against which the user operation is received is causing the predetermined event in the virtual space to proceed. Therefore, it is possible to further heighten a sense of unity among the users through progress of the predetermined event, and this makes it possible to maintain interest of the user in the video game.

### Fifth Embodiment

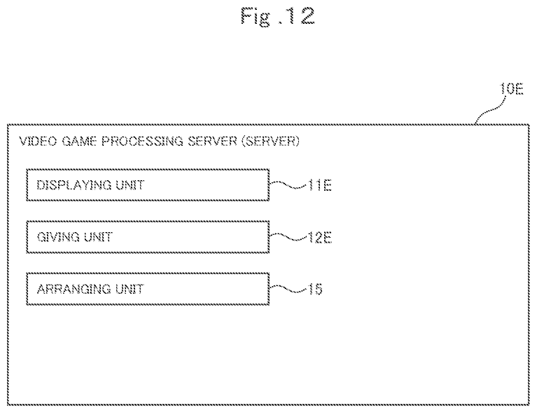

FIG. 12 is a block diagram illustrating a configuration of a video game processing server 10E (hereinafter, referred to as a “server 10E”), which is an example of the video game processing server 10. In the present embodiment, the server 10E at least includes a displaying unit 11E, a giving unit 12E, and an arranging unit 15.

The arranging unit 15 has a function to respectively arrange objects corresponding to a user and one or more other users who satisfy a predetermined condition with respect to the user (hereinafter, referred to as a “plurality of corresponding objects”) in a virtual space at positions defined in accordance with a predetermined arrangement rule.

Here, the arrangement rule is not limited particularly. However, it is preferable that the arrangement rule is a rule that the plurality of corresponding objects is arranged at positions that at least any of the user and the one or more other users who satisfy the predetermined condition with respect to the user can recognize. As an example of the arrangement rule, there is a rule that a plurality of corresponding objects is respectively arranged at positions separated from at least any of a user and one or more other users who satisfy a predetermined condition with respect to the user by a distance of a predetermined range.

Further, the phrase “arrange a plurality of corresponding objects at positions defined in accordance with a predetermined arrangement rule” means that the plurality of corresponding objects is respectively associated with the positions in the virtual space. A configuration to arrange the plurality of corresponding objects at the positions defined in accordance with the predetermined arrangement rule is not limited particularly. However, it is preferable that the server 10E is configured so that a plurality of corresponding objects is not displayed for a user and the other users corresponding to the plurality of corresponding objects.

The displaying unit 11E has a function to display information regarding a predetermined region for at least any of the user and the other users corresponding to the plurality of corresponding objects. The positions of the plurality of corresponding objects arranged by the arranging unit 15 are included in the predetermined region.

Here, the predetermined region in which the positions of the plurality of corresponding objects are included means a region that is defined in accordance with a predetermined region determining rule so as to include positions of a plurality of corresponding objects in the virtual space. The predetermined region in which the positions of the plurality of corresponding objects are included is not limited particularly. However, as an example of the predetermined region in which the positions of the plurality of corresponding objects are included, there is a region having a shape and an area that are defined on the basis of the number of users corresponding to the plurality of corresponding objects or a position of the user in the real world.

Further, the information regarding the predetermined region means information that at least contains information regarding a range of the predetermined region. The information regarding the predetermined region is not limited particularly. However, it is preferable that the information regarding the predetermined region is information that contains information that allows the user to assume positions of a plurality of corresponding objects included in a predetermined region. As an example of the information regarding the predetermined region, there is information regarding a positional relationship between the user and the predetermined region.

The phrase “display information regarding the predetermined region for at least any of the user and the other users corresponding to the plurality of corresponding objects” means that a user terminal 20 (hereinafter, referred to also as a “terminal 20”) of any of at least the user and the other users corresponding to the plurality of corresponding objects is caused to display the information regarding the predetermined region on a display screen thereof. A configuration to display information regarding the predetermined region for at least any of the user and the other users corresponding to the plurality of corresponding objects is not limited particularly. However, it is preferable that the displaying unit 11E is configured to display the information regarding the predetermined region and the positions in the virtual space so as to be associated with each other. As an example of the configuration to display information regarding the predetermined region for at least any of the user and the other users corresponding to the plurality of corresponding objects, there is a configuration in which in a case where a display position of a predetermined region in a virtual space or a predetermined region including the display position is included in a display region of the terminal 20, the terminal 20 of at least any of the user and the other users corresponding to corresponding objects is caused to display information regarding the predetermined region on the display screen thereof.

The giving unit 12E has a function to give a privilege specified on the basis of a giving condition, which corresponds to the plurality of corresponding objects arranged by the arranging unit 15, to at least any of the user and the other users corresponding to the plurality of corresponding objects in a case where the giving condition is satisfied.

Here, the giving condition means a condition tor at least any of the user and the other users corresponding to the plurality of corresponding objects to which the privilege is given. The giving condition is not limited particularly. However, it is preferable that the giving condition is a condition regarding the plurality of corresponding objects. As examples of the giving condition, there are a condition that a distance from a plurality of corresponding objects thus arranged is equal to or shorter than a predetermined distance, and a condition that a user operation against a plurality of corresponding objects thus arranges is received.

Further, the privilege specified on the basis of the giving condition is not limited particularly. However, it is preferable that the privilege is a privilege whose content is specified on the basis of the achieving difficulty of the giving condition As an example of the privilege specified on the basis of the giving condition, there is a privilege with the content that is specified on the basis of a distance between a position of any of a plurality of corresponding objects when the plurality of corresponding objects is arranged and a position of at least any of the user and the other users corresponding to the plurality of corresponding objects.

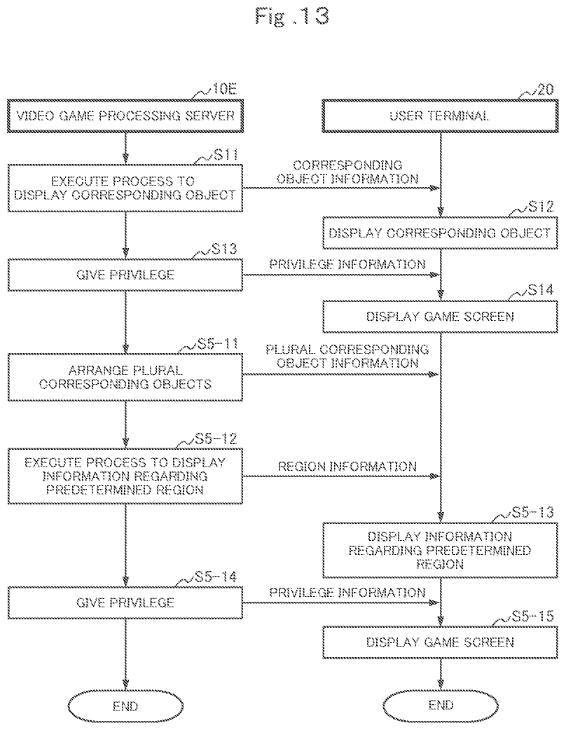

FIG. 13 is a flowchart illustrating an example of game processing executed by the video game processing system 100. Hereinafter, operations of the server 10E and the terminal 20 will be described as an example. In this regard, a flowchart illustrating an operation of each of the server 10E and the terminal 20 is omitted from a point of view to avoid repeated explanation.

The server 10E respectively arranges objects corresponding to a user and one or more other users who satisfy a predetermined condition with respect to the user (that is, a plurality of corresponding objects) at positions defined in accordance with a predetermined arrangement rule in a virtual space (Step S5-11). In the present embodiment, the server 10E transmits plural corresponding object information for arranging the plurality of corresponding objects to the terminal 20.

The server 10E executes a process to cause the terminal 20 to display information regarding a predetermined region, in which positions of the plurality of corresponding objects thus arranged are included, for the user (Step S5-12). In the present embodiment, the server 10E transmits region information for displaying the information regarding the predetermined region to the terminal 20.

When the region information is received from the server 10E, the terminal 20 outputs a game screen including the information regarding the predetermined region on the basis of the region information (Step S5-13).

In a case where a giving condition corresponding to the plurality of corresponding objects thus arranged is satisfied, the server 10E gives a privilege specified on the basis of the giving condition to the user (Step S5-14). In the present embodiment, the server 10E transmits privilege information for giving the privilege specified on the basis of the giving condition to the terminal 20.

When the privilege information is received from the server 10E, the terminal 20 outputs a game screen to a display screen of a predetermined display device on the basis of the privilege information (Step S5-15). In the present embodiment, when the terminal 20 outputs the game screen on the basis of the privilege information, the server 10E and the terminal 20 terminate the processes herein.

As explained above, as one aspect of the fifth embodiment, the server 10E provided with the functions to control progress of a video game using the positional information of the user terminal in response to the operation of the user is configured so as to include the displaying unit 11E, the giving unit 12E, and the arranging unit 15. Thus, the arranging unit 15 respectively arranges the objects corresponding to the user and the one or more other users who satisfy the predetermined condition with respect to the user as the plurality of corresponding objects in the virtual space at positions defined in accordance with the predetermined arrangement rule; the displaying unit 11E displays the information regarding the predetermined region, in which the positions of the plurality of corresponding objects thus arranged are included, for at least any of the user and the other users corresponding to the plurality of corresponding objects; and the giving unit 12E gives the privilege specified on the basis of the giving condition, which corresponds to the plurality of corresponding objects thus arranged, to at least any of the user and the other users corresponding to the plurality of corresponding objects in a case where the giving condition is satisfied. Therefore, it is possible to expect that the user and the other users cooperate with each other for the purpose of giving the privilege, and this makes it possible to maintain interest of the user in the video game.

### Sixth Embodiment

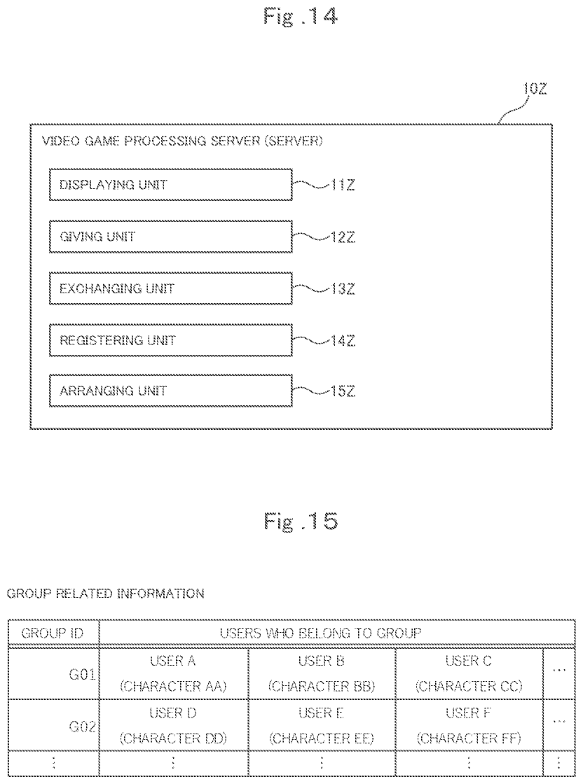

FIG. 14 is a block diagram illustrating a configuration of a video game processing server 10Z (hereinafter, referred to as a “server 10Z”), which is an example of the video game processing server 10. In the present embodiment, the server 10Z at least includes a displaying unit 11Z, a giving unit 12Z. an exchanging unit 13Z, a registering unit 14Z, and an arranging unit 15Z.

The displaying unit 11Z has a function to arrange an object corresponding to another user (that is, the other user or a second user), who satisfies a predetermined condition for a user (that is, a first user), (hereinafter, referred to as a “corresponding object”) and display the corresponding object at a position in a virtual space corresponding to a position of the other user in a real space for the user.

Here, the predetermined condition means a condition of the other user for which the object corresponding to the other user himself or herself can be displayed for the user Hereinafter, a case where the predetermined condition is to belong to the same group (or party) as the user will be described as an example.

Further, the other user means to be another user different from one user who uses a user terminal 20. Hereinafter, a case where the other user uses another user terminal 20 (for example, a user terminal 201) different from the user terminal 20 of the user will be described as an example.

Further, the position in the virtual space corresponding to the position of the other user in the real space means a position in the virtual space, which is defined in accordance with a predetermined rule on the basis of information indicating the position of the other user in the real space. Hereinafter, a case where the position of the other user in the real space is defined on the basis of positional information of the user terminal 201 of the other user and the position in the virtual space is a position in the virtual space corresponding to the positional information will be described as an example. In this regard, the positional information of the user terminal 201 means information indicating a position of the user terminal 201 in the real space, in the present embodiment, the positional information of the user terminal 201 is obtained using GPS signals. Hereinafter, a case where a virtual space corresponding to map information of a real space is a virtual space generated by using the map information of the real space will be described as an example.

Further, the virtual space corresponding to the map information of the real space means a virtual space that is generated by using the map information of the real space. Hereinafter, a configuration to generate a virtual space by respectively arranging objects corresponding to roads and buildings in the real space at positions corresponding to positions of the roads and the buildings in the real space will be described as an example.

Further, the phrase “arrange the corresponding object for the user” means that the corresponding object is associated with a position in the virtual space. Further, the phrase “display the corresponding object for the user” means that an image of the corresponding object is included in a game screen displayed by the user terminal 20 of the user. Hereinafter, a case where an object (hereinafter, referred to as an “other character object”) corresponding to a user character (hereinafter, referred to as an “other user character”) corresponding to the other user who belongs to the same group as the user is displayed for the user will be described as an example. In this regard, the verb “display” herein includes that the user terminal 20 mainly executes a process to display an image, and that the server 10A mainly executes a process to cause the user terminal 20 to display an image.

The giving unit 12Z has a function to give a specified privilege to at least any of the user and the other user corresponding to the corresponding object on the basis of a user operation against the corresponding object.

Here, the user operation against the corresponding object means an operation by the user against the corresponding object displayed by the displaying unit 11Z. Hereinafter, a case where the user operation against the corresponding object is a touch operation against the other character object will be described as an example.

Further, the privilege means something that is given to the user on the basis of a user operation. The content of the privilege is not limited particularly. It may be an element that the user can use, or may be an element that the user cannot use. As examples of the privilege, there are occurrence of a so-called buff, sharing of an item effect, participation in an event, an increase in an item appearance ratio, and an increase in an acquired experience value. Hereinafter, a case where recovery of a user character, a right to transmit a stamp (or a message) to the other user, or a participation right in a battle event by the other user character is given to the user as a privilege (or a benefit) will be described as an example.

In this regard, the participation right in the battle event by the other user character is not limited particularly. The participation right may be a right to participate in a battle event against an enemy character in which the other user character is fighting against the enemy character, or may be a right to participate in a battle event against an enemy character whose at least a part is different from an enemy character against which the other user character is fighting. Further, the participation right in the battle event by the other user character may be a right to independently participate in a battle by the user character, which is different from the battle against the enemy character by the other user character, and to allow a battle result to be shared between the user and the other user, in this regard, the server 10Z may be configured so that the other user character of the other user corresponding to the other character object is associated with the user on the basis of a touch operation against the other character object by the user. In addition, the server 10Z may be configured so that the associated user character participates in a battle event by the user character of the user in accordance with a predetermined rule (for example, a rule that becomes random, or a rule according to priority set in advance).

The exchanging unit 13Z has a function to exchange user information between the user and the other user in a case where an exchange request of the user information is received from the user or the other user.

Here, the user information means information regarding the user, and information that the user can identify, in the present embodiment, the user information may be a user ID, a user name, a user character name, or a code issued when the user information is exchanged.

Further, the exchange request of the user information means a request for exchanging user information among two or more users, in the present embodiment, the exchange request of the user information corresponds to a situation where the user terminal 20 issues a code for exchanging user information, for example.

Further, the phrase “exchange user information” means that a process regarding exchange of user information among two or more users is executed on the basis of the exchange request of the user information. A configuration to exchange the user information is not limited particularly. However, it is preferable that the exchanging unit 13Z is configured so that a user to be a host is defined. In the present embodiment, the configuration to exchange the user information is a configuration in which user information is transmitted and received between the user terminals 20, 201 by using the code displayed by the user terminal 20 of the user to be the host. Namely, in the present embodiment, in principle, the other user who can exchange the user information with the user is the other user who can confirm a display screen of the user terminal 20 of the user or can know code information from the user outside a video game. In this regard, as an example of the code, there is a QR code (registered trademark).

The registering unit 14Z has a function to register the other user who exchanges the user information as the other user who satisfies a predetermined condition for the user on the basis of the user information exchanged by the exchanging unit 13Z.

Here, the phrase “register the other user” means that the user and the other user are associated with each other on the basis of the user information of the other user. In the present embodiment, any of the other user characters corresponding to the other user who exchanges the other user information is registered to a group (or a party) of the user. In this regard, the server 10Z may be configured so that in a case where the other user is registered to the same group (or party) as the user, a right to cause the other user character of the other user to participate in a battle event by the user character of the user in accordance with a predetermined rule (for example, the rule that becomes random, or the rule according to priority set in advance) is given to the user as a privilege. Here, the server 10Z may be configured so that the other user character of the other user corresponding to the other character object is registered to the same group (or party) as the user on the basis of a touch operation by the user against the other character object.

The arranging unit 15Z has a function to respectively arrange objects corresponding to a user and one or more other users who satisfy a predetermined condition with respect to the user (hereinafter, referred to as a “plurality of corresponding objects”; for example, treasure box) in a virtual space at positions defined in accordance with a predetermined arrangement rule.

Here, the predetermined arrangement rule is not limited particularly. However, it is preferable that the predetermined arrangement rule is a rule that the plurality of corresponding objects is arranged at positions that at least any of the user and the one or more other users who satisfy the predetermined condition with respect to the user can recognize.

Further, the phrase “arrange a plurality of corresponding objects at positions defined in accordance with a predetermined arrangement rule” means that the plurality of corresponding objects is respectively associated with the positions in the virtual space. Hereinafter, a case where arranged treasure boxes are not displayed on the game screen will be described as an example. Further, in the present embodiment, the arranging unit 15Z does not arrange treasure boxed at the positions defined in accordance with the predetermined arrangement rule in a case whore a predetermined rate or more of a plurality of other users or all of the other users do not satisfy the predetermined condition with respect to the user.

Here, the displaying unit 11Z has a function to display information regarding a predetermined region for at least any of the user and the other users corresponding to the plurality of corresponding objects. The positions of the plurality of corresponding objects arranged by the arranging unit 15Z are included in the predetermined region.

Here, the predetermined region in which the positions of the plurality of corresponding objects are included means a region that is defined in accordance with a predetermined region determining rule so as to include positions of a plurality of corresponding objects in the virtual space, in the present embodiment, the predetermined region is a region in which a position of the treasure box is included.

Further, the information regarding the predetermined region means information that at least contains information regarding a range of the predetermined region. In the present embodiment, as the information regarding the predetermined region, the predetermined region in which the position of the treasure box is included is displayed by a radar

Further, the giving unit 12Z has a function to give a privilege specified on the basis of a giving condition, which corresponds to the plurality of corresponding objects arranged by the arranging unit 15Z, to at least any of the user and the other users corresponding to the plurality of corresponding objects in a case where the giving condition is satisfied.

Here, the giving condition means a condition for at least any of the user and the other users corresponding to the plurality of corresponding objects to which the privilege is given. In the present embodiment, the giving condition is a condition that a selection operation against the treasure box arranged in the virtual space or the vicinity of the treasure box is carried out.

FIG. 15 is an explanatory drawing for explaining an example of a storage state of information stored in a storage unit (not shown in the drawings) that is included in the server 10Z. As illustrated in FIG. 15, a group ID, and users who belong to a corresponding group together with user characters are stored in the storage unit as group related information so as to be associated with each other.

Here, the group ID means information for identifying a group.

Further, the users who belong to a corresponding group means users belonging to each group (or each party). In the present embodiment, in a case where a user is caused to belong to a group (and is registered), a user character corresponding to the user is also associated with the group. Here, a configuration to associate the user characters with the group is not limited particularly. However, the server 10Z may be configured so that in a case where a plurality of user characters corresponds to one user, at least any of the plurality of user characters is associated with the group. Further, a configuration to associate the user character with the group is not limited particularly. However, the server 10Z may be configured so that a plurality of user characters corresponding to one user is associated with one group. Further, the user who belong to the group is not limited particularly. However, the server 10Z may be configured so that any of users associated with a group is set as a representative user.

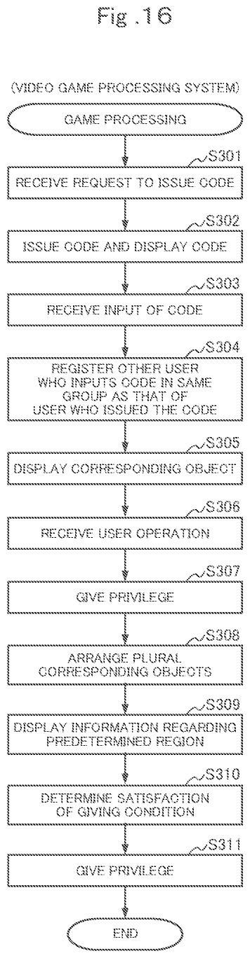

FIG. 16 is a flowchart illustrating an example of game processing executed by a video game processing system 100Z (hereinafter, referred to as a “system 100Z”) provided with the server 10Z. In the game processing according to the present embodiment, processes related to a control of progress of the video game using the positional information of the user terminal 20 (hereinafter, referred to as the “terminal 20”) in response to an operation of the user are executed. Hereinafter, each of the processes will be described. In this regard, the order of the processes may be changed without any contradiction or the like of processing content.

The game processing is as an opportunity that the terminal 20 accessing the server 10Z requests display of a virtual space, for example.

In the game processing, the system 100Z first receives a request to issue a code for exchanging user information from the terminal 20 of the user (Step S301), and issues the code for exchanging the user information to cause the terminal 20 of the user to display the issued code (Step S302).

When the code for exchanging the user information is issued to cause the terminal 20 of the user to display the issued code, the system 100Z receives an input of the code by a user terminal 20 of the other user (Step S303), and registers the other user to the same group as the user who issued the code (Step S304).

When the other user is registered to the same group as the user who issued the code, the system 100Z causes the user terminal of the other user to arrange an object corresponding to the other user who satisfies a predetermined condition with respect to the user (that is, a corresponding object) at a position in the virtual space, which corresponds to a position of the other user in a real space, and display the corresponding object for the user (Step S305). In the present embodiment, the system 1002 causes the user terminal of the other user to arrange other character object belonging to the same group as the user at the position in the virtual space, which corresponds to the position of the other user in the real space, and displays the arranged other character object for the user.

When the user terminal is caused to display the corresponding object, the system 100Z receives a user operation against the corresponding object from the user (Step S306), and gives a privilege specified on the basis of the user operation against the corresponding object to at least any of the user and the other user corresponding to the corresponding object (Step S307). In the present embodiment, in a case where a selection operation against an object corresponding to the other user character that belongs to the same group as the user is received from the user, the system 100Z gives the user a right to recover physical strength of the user character of the user or a right to transmit a message (or a stamp) to the other user.

When the privilege specified on the basis of the user operation is given, the system 100Z respectively arrange objects corresponding to the user and the one or more other users who satisfy the predetermined condition with respect to the user (that is, a plurality of corresponding objects) in a virtual space at positions defined in accordance with a predetermined arrangement rule (Step S308). In the present embodiment, the system 100Z respectively arranges treasure boxes corresponding to the user and the one or more other users who satisfy the predetermined condition with respect to the user, who belong to the same group, at positions defined in accordance with the predetermined arrangement rule.

When the plurality of corresponding objects is arranged, the system 100Z displays information regarding a predetermined region, in which the positions of the plurality of corresponding objects are included, for at least any of the user and the other users corresponding to the plurality of corresponding objects. The in the predetermined region (Step S309). In the present embodiment, the system 100Z displays the information regarding the predetermined region, in which the positions of the arranged treasure boxes are included, for any of the user and the other user corresponding to the plurality of corresponding objects as a radar.

The system 100Z determines that a giving condition is satisfied (Step S310), and gives a privilege specified on the basis of the giving condition to at least any of the user and the other users corresponding to the plurality of corresponding objects (Step S311). In the present embodiment, the system 100Z gives the privilege specified on the basis of the giving condition, and terminates the processes herein.

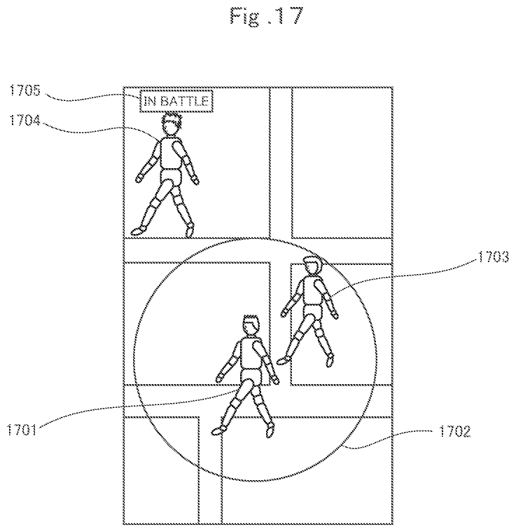

FIG. 17 is an explanatory drawing for explaining an example of a game screen. As illustrated in FIG. 17, a user character object 1701 of a user, an event generable region 1702 based on a position of the user character object 1701, other character objects 1703 and 1704, and information 1705 regarding event progress of another user corresponding to the other character object 1704 are illustrated in the game screen.

The user character object 1701 is an object corresponding to a user character of the user, is indicated at a place near the center of a display screen, and is displayed at a position in a virtual space corresponding to positional information of the terminal 20. When a position of the terminal 20 changes in a real space, the user character object 1701 similarly moves in the virtual space Further, the event generable region 1702 also moves in accordance with the movement of the user character object 1701.

The event generable region 1702 is a region satisfying a condition that the position of the user in the virtual space and the position of the object, which are included in a positional condition for generating an event corresponding to the object, have a predetermined relationship.

Each of the other character objects 1703 and 1704 is an object corresponding to a user character of the other user who belongs to the same group as the user. In the present embodiment, the object corresponding to the user character of the other user who belongs to the same group as the user is displayed on the display screen of the terminal 20 of the user. Further, in the present embodiment, when the user carries out a touch operation against the other character object 1703 positioned within the event generable region 1702, a screen for giving a privilege to at least any of the user and the other user is displayed.

The information 1705 regarding the event progress is information for indicating that the other user corresponding to the other character object 1704 is causing the event to proceed. In the present embodiment, the information 1705 regarding the event progress indicates that the other user corresponding to the other character object 1704 is causing a battle event to proceed.

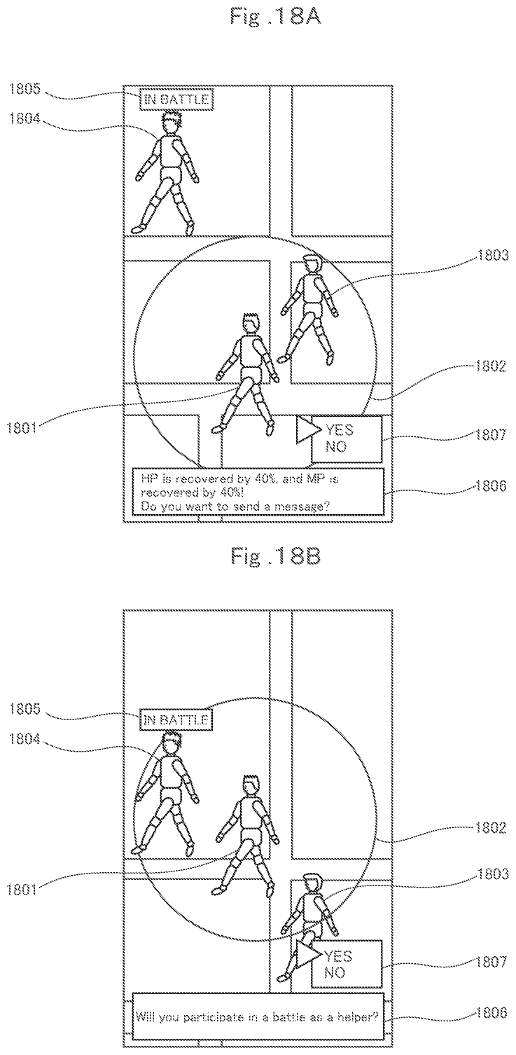

FIGS. 18A and 18B are explanatory drawings for explaining examples of a game screen. In FIGS. 18A and 18B, a user character object 1801 is similar to the user character object 1701; an event generable region 1802 is similar to the event generable region 1702; other character objects 1803 and 1804 are similar to the other character objects 1703 and 1704; and information 1805 regarding event progress is similar to the information 1705 regarding the event progress. Moreover, a sentence display region 1806 and a choice region 1807 are illustrated in each of FIGS. 18A and 18B.

The sentence display region 1806 is a region for displaying sentence information regarding a privilege specified on the basis of a touch operation against the user character of the other user. Of course, an image other than a sentence may be displayed in the sentence display region 1806. The example illustrated in FIG. 18A is a case where the user carries out a touch operation against the other character object 1803. Here, a fact that an HP and an MP of the user character of the user are recovered, and inquiry of whether a message is sent to the other user corresponding to the other character object 1803 against which the touch operation is carried out or not are displayed in the sentence display region 1806. Here, the inquiry indicates that a right to transmit the message as the privilege is given to the user.

Further, the example illustrated in FIG. 18B is a case where the user carries out a touch operation against the other character object 1804. Here, inquiry of whether the other user corresponding to the other character object 1804 participates in a battle event during progress as a helper or not is displayed in the sentence display region 1806. Similar to FIG. 18A, the inquiry indicates that a participation right in the battle event is given to the user as the privilege.

The choice region 1807 is a region in which the user carries out selection of the inquiry displayed in the sentence display region 1806 as the sentence information, in the examples of FIGS. 18A and 18B, choices for answering the inquiry displayed in the sentence display region 1806 is displayed. Here, when the user selects “YES”, a process corresponding to the sentence information displayed in the sentence display region 1806 is executed in the video game.

As explained above, as one aspect of the sixth embodiment, the server 10Z provided with the functions to control progress of a video game using the positional information of the user terminal in response to the operation of the user is configured so as to include the displaying unit 11Z, the giving unit 12Z, the exchanging unit 13Z, the registering unit 14Z, and the arranging unit 15Z. Thus, the displaying unit 11Z arranges the object corresponding to the other user, who satisfies a predetermined condition (for example, belonging to the same group) for the user, (the corresponding object, for example, the user character object in the same group) and displays the corresponding object at the position in the virtual space corresponding to the position of the other user in the real space for the user; and the giving unit 12Z gives the specified privilege (for example, recovery of character or a right to transmit a stamp) to at least any of the user and the other user corresponding to the corresponding object on the basis of the user operation against the corresponding object. Therefore, it becomes possible to maintain interest of the user in the video game.

Further, in the example of the sixth embodiment described above, the server 10Z is configured so that the exchanging unit 13Z exchanges the user information between the user and the other user in a case where the exchange request of the user information is received from the user or the other user; the registering unit 14Z registers the other user who exchanges the user information as the other user who satisfies a predetermined condition for the user on the basis of the exchanged user information. Therefore, it is possible to further activate interaction among the users, and this makes it possible to maintain interest of the user in the video game.

Further, in the example of the sixth embodiment described above, the server 10Z is configured so that the giving unit 12Z gives the participation right in the predetermined event specified on the basis of the user operation to the user as the privilege in a case where the other user corresponding to the corresponding object against which the user operation is received is causing the predetermined event to proceed in the virtual space. Therefore, a sense of unity among the users is further enhanced through progress of the predetermined event, and this makes it possible to maintain interest of the user in the video game.

Further, in the example of the sixth embodiment described above, the server 10Z is configured so that the arranging unit 15Z respectively arranges the objects corresponding to the user and the one or more other users who satisfy the predetermined condition with respect to the user as the plurality of corresponding objects in the virtual space at positions defined in accordance with the predetermined arrangement rule; the displaying unit 11Z displays the information regarding the predetermined region, in which the positions of the plurality of corresponding objects thus arranged are included, for at least any of the user and the other users corresponding to the plurality of corresponding objects; and the giving unit 12Z gives the privilege specified on the basis of the giving condition, which corresponds to the plurality of corresponding objects thus arranged, to at least any of the user and the other users corresponding to the plurality of corresponding objects in a case where the giving condition is satisfied. Therefore, it is possible to expect that the user and the other users cooperate with each other for the purpose of giving the privilege, and this makes it possible to further maintain interest of the user in the video game.

Further, it has not been mentioned particularly in the example of the sixth embodiment described above. However, the server 10Z may be configured so that the displaying unit 11Z arranges an object shared by the user and one or more other users who satisfy the predetermined condition with respect to the user in the virtual space or a position in the other virtual space, and displays the object for the user and the other user who satisfies the predetermined condition. Namely, in the example described above, the server 10Z may be configured so that a field or an enemy character in a group (or party) is shared.

Here, it has not been mentioned particularly in the example of the sixth embodiment described above. However an object shared by the user and the one or more other users who satisfy the predetermined condition with respect to the user (hereinafter, referred to as a “shared object”) means an object for which presence or absence of display, a position thereof, and the like are common among the user and the other users. Namely, the virtual space is shared among the user and the other users who satisfy the predetermined condition with respect to the user. Therefore, the objects arranged in the virtual space are also shared. For example, in a case where the shared object is not displayed in the virtual space that is displayed by the terminal 20 of the user by completing an event regarding the shared object by the user, the shared object is also not displayed in the virtual space that is displayed by the user terminal 201 of the other user who satisfies the predetermined condition for the user. Further, the server 10Z may be configured so that appearance of the shared object or the corresponding event is different from the other object. Further, the other virtual space means another virtual space for arranging and displaying the shared object. The other virtual space is not limited particularly. However, it is preferable that display of the other virtual space is restricted for user terminals of users other than the user and the other users who satisfy the predetermined condition with respect to the user. By configuring the server 10Z in this manner, it is possible to cause the user and the other users to share experience of progress of the video game, and this makes it possible to maintain interest of the user in the video game.

Further, it has not been mentioned particularly in the example of the sixth embodiment described above. However, the server 10Z may be configured so that a participation right in an event is given to the user as a privilege in a case where the other user corresponding to a displayed corresponding object is causing an event, in which the user and a plurality of other users are allowed to participate in the virtual space and to which restriction of the number of participants is set, to proceed and a request operation to participate in the event is received from the user. Namely, in the example described above, the server 10Z may be configured so that a right to participate in a battle is given to the user in a case where the other user belonging to the same group is causing a battle against a mega monster to proceed or is preparing the battle and a request operation to participate in the battle is received from the user.

Here, it has not been mentioned particularly in the example of sixth embodiment described above However, the request operation to participate in the event means a request operation that is carried out to participate in a specific event. The request operation to participate in the event is not limited particularly. However, it is preferable that the request operation to participate in the event is carried out in a situation where the user can recognize the content of the event. By configuring the server 10Z in this manner, in a case where it is usually difficult to share progress of the same event due to restriction of the number of participants, it is possible to share experience of progress of the video game among the user and the other users more surely, and this makes it possible to maintain interest of the user in the video game.

Further, it has not been mentioned particularly in the example of the sixth embodiment described above. However, the server 10Z may be configured so that an object corresponding to the other user who does not satisfy the predetermined condition with respect to the user is not displayed in the virtual space corresponding to a position of the other user in the real space. Namely, the server 10Z may be configured so that the object corresponding to the other user is not displayed for the user except that the predetermined condition is satisfied for the user. By configuring the server 10Z in this manner, it is possible to easily grasp the other users for which an object corresponding to the user is displayed on display screen of their user terminals, and as a result, it is possible to facilitate protection of personal information of the user.

As explained above, one or two or more shortages can be solved by each of the embodiments according to the present application, in this regard, the effects by each of the embodiments are non-limiting effects or one example of the non-limiting effects.

In this regard, in each of the embodiments described above, each of the plurality of user terminals 20, and 201 to 20N and the server 10 executes the various kinds of processing described above in accordance with various kinds of control programs (for example, a video game processing program) stored in the storage device with which the corresponding terminal or server is provided.

Further, the configuration of the system 100 is not limited to the configuration that has been explained as an example of each of the embodiments described above. For example, the system 100 may be configured so that the server 10 executes a part or all of the processes that have been explained as the processes executed by the user terminal 20. Alternatively, the system 100 may be configured so that any of the plurality of user terminals 20, and 201 to 20N (for example, the user terminal 20) executes a part or all of the processes that have been explained as the processes executed by the server 10. Further, the system 100 may be configured so that a part or all of the storage unit included in the server 10 is included in any of the plurality of user terminals 20, and 201 to 20N. Namely, the system 100 may be configured so that a part or all of the functions of any one of the user terminal 20 and the server 10 according to the system 100 is included in the other.

Further, the system 100 may be configured so that the program causes a single apparatus to perform a part or all of the functions that have been explained as the example of each of the embodiments described above without including a communication network.

### Appendix

The explanation of the embodiments described above has been described so that the following embodiments can be at least performed by a person having a normal skill in the art to which the present disclosure belongs.

(1)

A non-transitory computer-readable medium including a video game processing program for causing a server to perform functions to control progress of a video game in which display of information regarding a second user is restricted using positional information of a user terminal of a first user and information regarding a virtual space corresponding to map information of a real space, the functions comprising:

a displaying function configured to arrange an object corresponding to the second user who satisfies a predetermined condition for the first user as a corresponding object, and display the corresponding object at a position in the virtual space corresponding to a position of the second user in the real space for the first user; and

a giving function configured to give a privilege to at least any of the first user and the second user corresponding to the corresponding object, the privilege being specified on a basis of a user operation against the corresponding object.

(2)

The non-transitory computer-readable medium according to (1),

wherein the predetermined condition is a condition that the second user belongs to a same group as the first user, and

wherein the displaying function includes a function configured to arrange an object corresponding to the second user who belongs to the same group as the first user as the corresponding object and display the corresponding object in the virtual space for the first user.

(3)

The non-transitory computer-readable medium according to (1) or (2), the functions further comprising:

an exchanging function configured to exchange user information between the first user and the second user in a case where an exchange request of the user information is received from the first user or the second user; and

a registering function configured to register the second user who exchanges the user information as the second user who satisfies the predetermined condition for the first user on a basis of the user information exchanged by the exchanging function.

(4)

The non-transitory computer-readable medium according to any one of (1) to (3),

wherein the giving function includes a function configured to give a participation right in a predetermined event specified on a basis of a user operation to the first user as the privilege in a case where the second user corresponding to the corresponding object against which the user operation is received is causing the predetermined event to proceed in the virtual space.

(5)

The non-transitory computer-readable medium according to any one of (1) to (4), the functions further comprising:

an arranging function configured to respectively arrange objects corresponding to the first user and one or more second users who satisfy the predetermined condition with respect to the first user in the virtual space at positions defined in accordance with a predetermined arrangement rule as a plurality of corresponding objects,

wherein the displaying function includes a function configured to display information regarding a predetermined region for at least any of the first user and the second user corresponding to the plurality of corresponding objects, the positions of the plurality of corresponding objects arranged by the arranging function being included in the predetermined region, and

wherein the giving function includes a function configured to give a privilege specified on a basis of a giving condition, which corresponds to the plurality of corresponding objects arranged by the arranging function, to at least any of the first user and the second user corresponding to the plurality of corresponding objects in a case where the giving condition is satisfied.

(6)

The non-transitory computer-readable medium according to any one of (1) to (5),

wherein the displaying function includes a function configured to arrange an object shared by the first user and one or more second users who satisfy the predetermined condition with respect to the first user at a position in the virtual space or another virtual space, and display the object for the first user and the second users who satisfy the predetermined condition.

(7)

The non-transitory computer-readable medium according to any one of (1) to (6),

wherein the giving function includes a function configured to give a participation right in an event in the virtual space to the first user as the privilege in a case where the second user corresponding to the corresponding object displayed by the displaying function is causing the event to proceed and a request operation to participate in the event is received from the first user, the event having a limited number of participants among the first user and a plurality of second users.

(8)

The non-transitory computer-readable medium according to any one of (1) to (7),

wherein the displaying function includes a function configured not to display an object corresponding to the second user who does not satisfy the predetermined condition with respect to the first user in the virtual space corresponding to the position of the second user in the real space.

(9)

A non-transitory computer-readable medium including a video game processing program for causing a user terminal to perform at least one function of the functions that the video game processing program described in any one of (1) to (8) causes the server to perform, the user terminal being capable of communicating with the server.

(10)

A video game processing system for controlling progress of a video game in which display of information regarding a second user is restricted using positional information of a user terminal of a first user and information regarding a virtual space corresponding to map information of a real space, the video game processing system comprising a communication network, a server, and the user terminal, the video game processing system further comprising:

a display controller configured to arrange an object corresponding to the second user who satisfies a predetermined condition for the first user as a corresponding object, and display the corresponding object at a position in the virtual space corresponding to a position of the second user in the real space for the first user; and

a giver configured to give a privilege to at least any of the first user and the second user corresponding to the corresponding object, the privilege being specified on a basis of a user operation against the corresponding object.

(11)

The video game processing system according to (10),

wherein the server includes the display controller and the giver, and

wherein the user terminal includes an output controller configured to output a game screen to a display screen of a display device, the game screen indicating a state of the corresponding object arranged and displayed by the display controller.

(12)

A non-transitory computer-readable medium including a video game processing program for causing a user terminal to perform functions to control progress of a video game in which display of information regarding a second user is restricted using positional information of the user terminal of a first user and information regarding a virtual space corresponding to map information of a real space, the functions comprising:

a displaying function configured to arrange an object corresponding to the second user who satisfies a predetermined condition for the first user as a corresponding object, and display the corresponding object at a position in the virtual space corresponding to a position of the second user in the real space for the first user; and

a giving function configured to give a privilege to at least any of the first user and the second user corresponding to the corresponding object, the privilege being specified on a basis of a user operation against the corresponding object.

(13)

A video game processing method of controlling progress of a video game in which display of information regarding a second user is restricted using positional information of a user terminal of a first user and information regarding a virtual space corresponding to map information of a real space, the video game processing method comprising:

a displaying process configured to arrange an object corresponding to the second user who satisfies a predetermined condition for the first user as a corresponding object, and display the corresponding object at a position in the virtual space corresponding to a position of the second user in the real space for the first user; and

a giving process configured to give a privilege to at least any of the first user and the second user corresponding to the corresponding object, the privilege being specified on a basis of a user operation against the corresponding object.

(14)

A video game processing method of controlling progress of a video game by a video game processing system, display of information regarding a second user being restricted using positional information of a user terminal of a first user and information regarding a virtual space corresponding to map information of a real space in the video game, the video game processing system comprising a communication network, a server, and a user terminal, the video game processing method comprising:

a displaying process configured to arrange an object corresponding to the second user who satisfies a predetermined condition for the first user as a corresponding object, and display the corresponding object at a position in the virtual space corresponding to a position of the second user in the real space for the first user; and

a giving process configured to give a privilege to at least any of the first user and the second user corresponding to the corresponding object, the privilege being specified on a basis of a user operation against the corresponding object.

### INDUSTRIAL APPLICABILITY

According to one of the embodiments of the present disclosure, it is useful to allow interest of a user in a video game to be maintained.

What is claimed is:

1. A non-transitory computer-readable medium storing a video game processing program for causing a computer of a server to perform functions to control progress of a video game on user terminals of first and second users, the functions comprising: restricting the user terminal of the first user to display information regarding the second user by using positional information of the user terminal of the first user and information regarding a virtual space corresponding to map information of a real space;
arranging an object corresponding to the second user who satisfies a predetermined condition with respect to the first user as a corresponding object;
causing the user terminal of the first user to display the corresponding object at a position in the virtual space corresponding to a position of the second user in the real space for the first user; and
giving a privilege to at least any of the first user or the second user corresponding to the corresponding object based on a user operation against the corresponding object.

2. The non-transitory computer-readable medium according to claim 1,
wherein the predetermined condition is that the second user belongs to a same group as the first user.

3. The non-transitory computer-readable medium according to claim 1, the functions further comprising:
exchanging user information between the first user and the second user when an exchange request of the user information is received from the first user or the second user; and
registering the second user who exchanges the user information as the second user who satisfies the predetermined condition for the first user based on the exchanged user information.

4. The non-transitory computer-readable medium according to claim 1,
wherein the privilege includes a participation right in a predetermined event to the first user based on the user operation by the first user against the corresponding object, when the second user is causing the predetermined event to proceed in the virtual space.

5. The non-transitory computer-readable medium according to claim 1, the functions further comprising:
respectively arranging objects corresponding to the first user and one or more second users who satisfy the predetermined condition with respect to the first user in the virtual space at positions defined in accordance with a predetermined arrangement rule as one or more corresponding objects; and
causing the user terminal of at least any of the first user or the one or more second users corresponding to the one or more corresponding objects to display information regarding a predetermined region including the positions of the one or more corresponding objects; and
giving a privilege to at least any of the first user and the second user corresponding to the one or more corresponding objects when a giving condition corresponding to the one or more corresponding objects is satisfied.

6. The non-transitory computer-readable medium according to claim 1,
wherein arranging the object includes arranging the object at a position in the virtual space or another virtual space, the object being shared by the first user and one or more second users who satisfy the predetermined condition with respect to the first user, and
wherein causing the user terminal of the first user to display includes causing the user terminals of the first user and the second users who satisfy the predetermined condition to display the object.

7. The non-transitory computer-readable medium according to claim 1,
wherein the privilege includes a participation right in an event in the virtual space to the first user when the second user corresponding to the corresponding object is causing the event to proceed and when a request operation to participate in the event is received from the first user, the event comprising a limited number of participants among the first user and a plurality of second users.

8. The non-transitory computer-readable medium according to claim 1, the functions further comprising:
causing the user terminal of the first user not to display an object corresponding to the second user who does not satisfy the predetermined condition in the virtual space corresponding to the position of the second user in the real space.

9. A video game processing system configured to control progress of a video game comprising:
a communication network;
a server;
a user terminal of a first user configured to be restricted displaying information regarding a second user by using positional information of the user terminal of the first user and information regarding a virtual space corresponding to map information of a real space;
a display controller configured to arrange an object corresponding to the second user who satisfies a predetermined condition with respect to the first user as a corresponding object, and further configured to cause the terminal of the first user to display the corresponding object at a position in the virtual space corresponding to a position of the second user in the real space; and
a processor configured to give a privilege to at least any of the first user or the second user corresponding to the corresponding object based on a user operation against the corresponding object.

10. A non-transitory computer-readable medium storing a video game processing program for causing a computer of a user terminal of a first user to perform functions to control progress of a video game, the functions comprising:
restricting displaying of information regarding a second user using positional information of the user terminal of a first user and information regarding a virtual space corresponding to map information of a real space;
arranging an object corresponding to the second user who satisfies a predetermined condition for the first user as a corresponding object;
displaying the corresponding object at a position in the virtual space corresponding to a position of the second user in the real space for the first user; and
giving a privilege to at least any of the first user or the second user corresponding to the corresponding object based on a user operation against the corresponding object.
